(19) United States
(12) Patent Application Publication
(10) Pub. No.: US 2024/0010176 A1
(43) Pub. Date: Jan. 11, 2024

(54) PARKING-BRAKING ASSEMBLY AND METHOD

(71) Applicant: BREMBO S.p.A., Curno (Bergamo) (IT)

(72) Inventors: Andrea MILANESI, Curno (Bergamo) (IT); Beniamin SZEWCZYK, Curno (Bergamo) (IT); Alessandro CIOTTI, Curno (Bergamo) (IT); Paolo SALA, Curno (Bergamo) (IT)

(73) Assignee: BREMBO S.p.A., Curno (Bergamo) (IT)

(21) Appl. No.: 18/252,415

(22) PCT Filed: Nov. 11, 2021
(86) PCT No.: PCT/IB2021/060433

§ 371 Date: May 10, 2023

(30) Foreign Application Priority Data
Nov. 12, 2020 (IT) 102020000027071

(51) Int. Cl. B60T 13/74; B60T 1/06; F16D 65/18; F16D 55/224; F16D 55/228

(52) U.S. Cl. CPC B60T 13/746; B60T 1/065; F16D 65/18; F16D 65/183; F16D 55/224; F16D 55/228; F16D 2121/24

(57) ABSTRACT

A parking-braking assembly of a motor vehicle is provided. The parking-braking assembly has at least one first brake caliper associated with a wheel of the rear axle of the vehicle and at least one further first brake caliper associated with a wheel of the front axle of the vehicle. All brake calipers of the parking-braking assembly are electro-actuated brake calipers to avoid hydraulic braking devices and circuits on the vehicle. The at least one first brake caliper and the at least one further first brake caliper are at least also parking brake calipers.

### FIELD OF THE INVENTION

The present invention relates to the field of electric brakes and in particular of electric park brakes (EPB) of a vehicle, even more particularly of a motor vehicle. In greater detail, the present invention relates to an electronic device for selecting and routing electrical signals for operating the electro-actuated brake calipers of a brake apparatus, in particular a parking brake of a motor vehicle, even more particularly a motorcar.

### BACKGROUND ART

As known, the braking systems primarily serve two purposes: service braking and parking braking. The term “service braking” means any action on the braking system to apply braking or deceleration on a moving vehicle, including parking but under the command of the driver or an equivalent driver assistance system. In particular, “service braking” produces a vehicle deceleration which can be modulated and is reversible, because removing the command cancels the action. Conversely, the term “parking braking” means a braking action while the vehicle is stationary, usually but not necessarily off, and not under the command of the driver or the driver assistance system, e.g., the braking action of the vehicle while parked with no-one on-board. In other words, “parking braking” produces a force which prevents the vehicle from moving even after the command is removed, i.e. it is characterized by being irreversible. The removal of the force requires a specific release command. Both functions can be activated under the driver's command or the command of other driver assistance systems.

Nowadays, electric park brakes (EPBs) are used on motor vehicles, in particular motorcars, to keep the vehicle stationary on both sloping and flat roads. The same function was accomplished in the past using a manual parking brake.

Such electric park brakes involve the use of electro-actuated brake calipers, i.e. operated by electric motors dedicated to the parking brake function.

The retaining mechanism of the electric park brake of a motorcar is activated by the driver acting on a button. As a result of such activation, an electronic control system activates the electric motors positioned on the calipers to advance the pistons which apply a bias on the respective pads, which abut on brake disc braking surfaces associated with the wheel of the motorcar and, consequently, stop its movement. As known, in most cases, the parking brake, either manual or EPB, acts on the rear axle wheels of the motorcar.

In some cases, the brake calipers used to apply a parking brake action are specially made brake calipers which are separate from the brake calipers used to apply the service braking action. Indeed, since there are no moving masses, the energy involved in parking braking is decidedly less than the energy that the service brake must apply.

Usually, service brake calipers are known which are also used as parking brake calipers, e.g. as described in U.S. Pat. Nos. 3,734,248, 5,343,985, US2016167632, U.S. Pat. No. 5,090,518, US2009242338, US2014076672, U.S. Ser. No. 10/525,958, and US2019120311.

An electric park brake apparatus EPB involves the use of an electronic control unit (ECU) and an actuator adapted to act on the electric motors of the electro-actuated calipers. For this reason, EPB systems can be considered as a subset of braking systems operating with brake-by-wire (BBW) technology.

To drive an electric motor for actuating an electro-actuated caliper of an EPB parking brake, it is known to use a dedicated power electronic circuit, e.g. an electronic circuit in a full-bridge transistor configuration (in case of driving using a circuit which includes solid-state components) or an electronic circuit using switching relays (in case of driving using a switch).

In particular, the known and currently available EPB parking brake apparatuses are made according to two different implementation types:
a first type of parking brake includes the use of a specific electronic control unit, or ECU, dedicated to it, which includes two power electronic circuits in a full-bridge transistor configuration, each of which can be used to drive an electric motor associated with a brake caliper;
a second type of parking brake involves the use of two power electronic circuits in a full-bridge configuration with transistors either included or integrated into an ABS/ESP control unit which already equips the motorcar. Again, each full-bridge power circuit can be used to drive a single electric motor associated with a brake caliper.

The search for new actuation solutions for an electric park brake applicable to brake calipers of the monobloc or floating type has recently led to the design of electro-actuated calipers which include two or more electric motors for each caliper, dedicated to the parking braking function.

To be controlled, this type of caliper would require a new electronic control unit capable of driving four or more motors, or the use of a dedicated electronic control unit for each caliper, because the known apparatuses currently used to control the EPB only drive two electric motors.

The control of such calipers would, thus, require an overly complex and economically disadvantageous EPB electric park brake apparatus.

First of all, the need to improve the braking action and in particular the parking braking action is still felt.

Therefore, the need is strongly felt to control electro-actuated calipers which include two or more electric motors for each caliper, dedicated to the parking brake function of vehicles which makes it possible to overcome the limitations and drawbacks of the known solutions mentioned above.

The need is also felt to avoid the anomalous behavior of the brake caliper when it is also used as a parking brake caliper. For example, the need is felt when the caliper has more than one electric motor actuating the caliper to ensure that the resulting action on the pad does not result in “skewing” of the pad itself, i.e. the action of the pad which results in its abnormal movement in its housing provided in the caliper body, generating among other matters, excessive dissymmetrical or asymmetrical loads on the brake caliper body.

### Solution

It is a first object of the present invention to devise and make available a parking-braking assembly of a vehicle according to claim 1 which makes is possible to solve the problems of the solutions of the prior art and also makes it possible to satisfy the felt needs.

Some advantageous embodiments are the object of the dependent claims.

The present invention further relates to a parking-braking method of a vehicle according to claim 7.

Some advantageous embodiments are the object of the dependent claims.

The analysis of these solutions showed that the making of a parking-braking assembly according to the invention (thus also present on the front calipers or the front axle of the vehicle) makes it possible to solve the problems of the known solutions and achieve the felt and remaining unmet needs. For example, the following benefits can be obtained as a result of the invention:
preparing a brake assembly which can be used in autonomous driving vehicles;
obtaining greater safety for off-road vehicles where it is not always possible to park with all the rear and/or front wheels on the ground and thus keep the parked vehicle braked and stationary;
making it possible to park on higher slopes or alternatively obtain a reduction of the parking force required to the single actuator with consequent resizing and reducing the overall dimensions and weight of these assemblies which constitutes an unsprung weight of the vehicle which it is always desirable to minimize.

### FIGURES

Further features and advantages of the invention will become apparent from the description provided below of preferred exemplary embodiment thereof, given by way of non-limiting example, with reference to the accompanying drawings, in which:

FIG. 1 diagrammatically illustrates an example of an EPB parking brake apparatus comprising an electronic selecting and routing device of electrical signals for actuating electro-actuated brake calipers according to the present invention, connected between an electronic control unit of the EPB apparatus and electro-actuated brake calipers of a motor vehicle including two electric motors for each caliper;

FIG. 2 illustrates a time-dependent diagram of the control signals of electronic switches controlled in switching included in the electronic selecting and routing device in FIG. 1;

FIG. 3 diagrammatically shows a vehicle and, with greatly enlarged, separate parts, the two brake calipers, each of which of the monobloc type with four pistons and four independent electric motors, each associated respective front wheels, and the two floating brake calipers each with only one piston and the respective electric motor associated with the two rear wheels;

FIG. 4 again diagrammatically shows a second vehicle configuration and, with greatly enlarged, separate parts, two brake calipers, each of which of the floating type with two pistons and four independent electric motors, each associated with a respective front wheel, and the two floating brake calipers each with only one piston and the respective electric motor, each associated with each rear wheel;

FIG. 5 shows an axonometric view of a monobloc brake caliper associated with a brake disc with four pistons driven by four independent electric motors;

FIG. 6 shows an axonometric view of a floating brake caliper with two pistons driven by two independent electric motor-reducers;

FIG. 7 shows an axonometric view of a floating brake caliper with a single piston driven by an electric motor-reducer;

FIG. 8 shows an axonometric view of a hydraulic and electromechanical service and parking disc brake comprising a monobloc brake caliper with two hydraulically operated pistons (service brake) and two independent electric motors (parking brake);

FIG. 9 shows a section view of the brake caliper for disc brake in FIG. 8;

FIG. 10 shows an enlarged view of a detail in FIG. 9.

Similar or equivalent elements in the aforesaid figures are indicated with the same reference numerals.

### DESCRIPTION OF SOME PREFERRED EMBODIMENTS

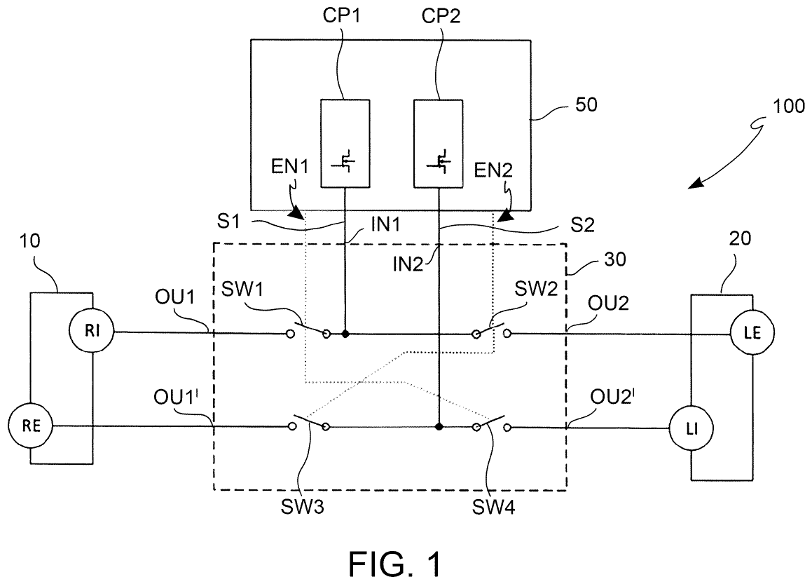

With reference to FIG. 1, a simplified block diagram of a parking brake apparatus (Electric Park Brakes or EPB) of a motor vehicle, in particular a motorcar, according to the present invention is indicated by reference numeral 100 as a whole.

In the present description, the term “stationary” is used to indicate that the motorcar is parked and with the engine off. In such conditions, the retaining mechanism of the electric park brake of a motorcar is activatable by the driver, e.g., by acting on a button. Following such activation, the brake calipers are actuated by the electric motors to apply the respective pads to the brake discs of the wheels of the motorcar and, consequently, block them.

Similarly, the electric parking brake retaining mechanism is deactivated by the driver by pressing the button again.

It is worth noting that the aforesaid parking-braking apparatus 100 is configured to implement the electric park brake function by employing components already included in the electro-actuated brake apparatus which equips the motorcar, including an electronic control unit 50 of the brake apparatus and electro-actuated brake calipers 10, 20 acting on the brake discs of the wheels of the motorcar.

In the present invention, in particular, said electro-actuated brake calipers 10, 20 of the apparatus 100 may include one, two, or more electric motors for each caliper. Referring to the example in FIG. 1, each of the electro-actuated brake calipers 10, 20 comprise two electric motors. As known, each of such motors is adapted to actuate a respective piston (not shown in FIG. 1) which, by acting on one or another of the semi-calipers which make up each brake caliper 10, 20, determines the clamping of the caliper on the brake disc or, vice versa, the releasing from the disc.

In particular, in the example of FIG. 1, the parking brake apparatus 100 comprises a first 10 and a second 20 electro-actuated brake caliper.

The first electro-actuated brake caliper 10 comprises, for example, a first RI and at least a further first RE electric motor. The second electro-actuated brake caliper 20 comprises, for example, a second LE and at least a further second LI electric motor.
In other words, each caliper 10, 20 comprises a first electric motor RI, LI adapted to act on the semi-caliper facing towards the inside of the motorcar, and a second electric motor RE, LE adapted to act on the semi-caliper facing towards the outside of the motorcar 2.

In an example of embodiment the aforesaid first 10 and second 20 electro-actuated brake calipers are associated with the wheels of the rear axle 5 of the motorcar 2.

In a different example of embodiment, the aforesaid first 10 and second 20 electro-actuated brake caliper are associated with the wheels of the front axle 6 of the motorcar 2.

These solutions are both equivalently applicable to keep the vehicle stationary on both sloping and flat roads.

In yet a different example of embodiment, the first electro-actuated brake caliper 10 is associated with a wheel of the rear axle 5 of the motorcar, and the second electro-actuated brake caliper 20 is associated with a wheel of the front axle 6 of the motorcar 2.

Such a configuration is particularly advantageous because it makes it possible to keep the motorcar stationary if it is parked on uneven roads which have different slopes at the wheels of the rear and front axle.

Furthermore, the parking brake apparatus 100 comprises the aforesaid electronic control unit 50 (or ECU), which comprises, for example, a microcontroller or microprocessor, configured to generate a first S1 and a second S2 electrical signal for actuating the electro-actuated brake calipers 10, 20.

Hereafter, reference will be made in general to the aforementioned electric actuation signals S1, S2, meaning that such signals can indifferently actuate the electric motors (and the respective pistons) to determine the clamping of the caliper on the brake disc, or vice versa, the release from the disc.

In an example of embodiment, such an electronic control unit 50 is embodied in a dedicated electronic control unit which includes a first CP1 and a second CP2 power electronic circuit, e.g. in a full-bridge transistor configuration, configured to generate the first S1 and the second S2 electrical signal, respectively, for actuating the electro-actuated brake calipers 10, 20.

In a different example of embodiment, such an electronic control unit 50 is embodied in an ABS/ESP control unit which already equips the motorcar. In such a case, the use of a first CP1 and a second CP2 additional power electronic circuit is included, e.g. in a full-bridge transistor configuration, either included or integrated into said ABS/ESP control unit and adapted to generate the first S1 and the second S2 electrical signal for actuating the electro-actuated brake calipers 10, 20.

Furthermore, the parking brake apparatus 100 of the invention advantageously comprises an electronic device 30 for selecting and routing the electrical signals for actuating the electro-actuated brake calipers 10, 20 of the apparatus.

In particular, said electronic device 30 comprises a first IN1 and a second IN2 input for receiving the aforesaid first S1 and second S2 electrical drive signal generated by the electronic control unit 50.

Furthermore, the electronic device 30 comprises:
a first OU1 and at least a further first OU1′ output connected to the first RI and the at least a further first RE electric motors, respectively, of the first electro-actuated brake caliper 10;
a second OU2 and at least a further second OU2′ output connected to the second LE and the at least a further second LI electric motors, respectively, of the second electro-actuated brake caliper 20.

Furthermore, the electronic device 30 of the invention comprises electronic connection means SW1, SW2, SW3, SW4 which can be controlled to assume an open state and a closed state.

In particular, when the parking brake apparatus 100 is deactivated, said electronic connecting means SW1, SW2, SW3, SW4 are controlled to assume the open state. Thus, the first IN1 and second IN2 inputs are isolated from the aforesaid outputs OU1, OU1′, OU2, OU2′.
Instead, when the parking brake apparatus 100 is activated, said electronic connection means SW1, SW2, SW3, SW4 are selectively controlled to switch from the open state to the closed state to connect the aforesaid first IN1 and second IN2 input of the device 30 to any two of: first output OU1, second output OU2, at least one further first output OU1′ and at least one further second output OU2′.

In this manner, the electrical actuation signals S1, S2 are routed towards the selected electric motors of the electro-actuated brake calipers.

In an example of embodiment provided by way of a non-limiting example of the present invention, the aforesaid electronic switching means comprise a first SW1, a second SW2, at least a third SW3, and at least a fourth SW4 switch controlled in switching.

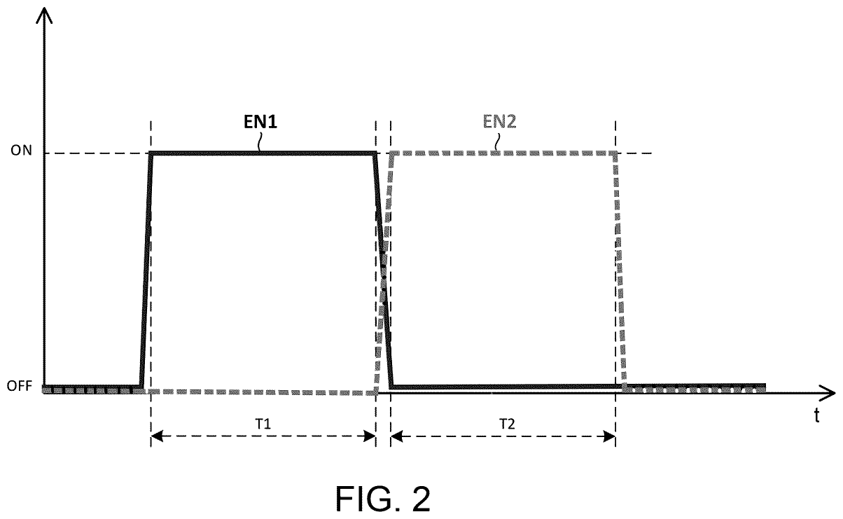

In particular, said electronic switches are controllable in switching based on a first EN1 and a second EN2 control signal generated by the electronic control unit 50 and having time trends shown, for example, in FIG. 2.

In the example in FIG. 1, the parking brake apparatus 100 comprises two calipers, and each of those calipers includes two electric motors. Therefore, the selecting and routing device 30 comprises a total of four electronic switches.

However, the teachings of the present invention are also applicable to the case of brake apparatuses employing calipers each of which comprises more than two electric motors. The person skilled in the art can modify the number and configuration of the electronic switches of the selecting device 30 so that the two actuation signals S1, S2 are always routed to any two of these motors.

In the example of embodiment in FIG. 1, the first control signal EN1 is adapted to act at the same time on the first SW1 and the fourth SW4 switch, the second control signal EN2 can act at the same time on the second SW2, and the third SW3 switch.

In such an example of embodiment, when the parking brake apparatus 100 is activated:

said first SW1 and the fourth SW4 switches are controlled by means of the first control signal EN1 to switch from the open state to the closed state to connect, during a first time interval T1, the first input IN1 to the first output OU1 of the device 30 and to connect the second input IN2 to said at least a further second output OU2′, respectively.
In this case, the second SW2 and third SW3 switches are controlled by the second EN2 control signal to assume the open state.

In the same example, when the parking brake apparatus 100 is activated, at the end of the first time interval T1:
the first SW1 and fourth SW4 switches are controlled by the first EN1 control signal to switch from the closed state to the open state,
the second SW2 and the third SW3 switches are controlled by the second control signal EN2 to switch from the open state to the closed state to connect, during a second time interval T2 following the first time interval T1, the first input IN1 to the second output OU2 of the device 30 and to connect the second input IN2 to said at least a further first output OU1′, respectively.

In a different example of embodiment, not shown in FIG. 1, the first control signal EN1 can act at the same time on the first SW1 and the third SW3 switch, the second control signal EN2 is adapted to act at the same time on the second SW2 and the fourth SW4 switch.

In such an example of embodiment, when the parking brake apparatus 100 is activated:

said first SW1 and third SW3 switches are controlled by means of the first control signal EN1 to switch from the open state to the closed state to connect, during a first time interval T1, the first input IN1 to the first output OU1 of the device 30 and to connect the second input IN2 to said at least a further first output OU1′, respectively;
the second SW2 and the fourth SW4 switches are controlled to assume the open state.

In the same example, when the parking brake apparatus 100 is activated, at the end of the first time interval 1i:
the first SW1 and the third SW3 switches are controlled to switch from the closed state to the open state,
said second SW2 and fourth SW4 switches are controlled to switch from the open state to the closed state to connect, during a second time interval T2 following the first time interval T1, the first input IN1 to the second output OU2 of the device 30 and to connect the second input IN2 to said at least a further second output OU2′, respectively.

In view of the above, the electronic device 30 for selecting and routing the input signals IN1, IN2 is adapted to operate as a demultiplexer on such signals.

In the aforesaid examples of embodiment shown above, the first EN1 and the second EN2 control signals are, for example, square wave signals having the same frequency, but mutually shifted by 180°.

In such a case, the first T1 and second T2 time intervals are equal to each other and coincide with a half-period of such square wave signals.

The duration of this semi-period is fixed and, for example, is in the range 10 msec-100 msec.

In a yet different example of embodiment, the first EN1 control signal coincides with the second EN2 control signal. In other words, the first SW1 and fourth SW4 switches are controlled to assume the closed state at the same time as the second SW2 and third SW3 switches.

In such a case, when the parking brake apparatus 100 is activated, the first SW1, second SW2, third SW3, and fourth SW4 switch are controlled to switch from the open state to the closed state and remain closed at the same time during a third time interval T3 (not shown in the figures). Thus, the first input IN1 is connected at the same time to the first OU1 and the second OU2 output, and the second input IN2 is connected at the same time to the at least one further first OU1′ and the at least one further second OU2′ output.

In particular, the Applicant has verified that by introducing the electronic device 30 for selecting and routing electric actuation signals described above, it is possible to effectively drive two electro-actuated brake calipers each including at least two electric motors employing the same electronic control unit 50 already provided in the electro-actuated brake control apparatus, without excessively increasing the complexity of the brake apparatus.

Furthermore, the electronic selection and routing device 30 can be used to alternately drive the electric motors of any two brake calipers of the parking brake apparatus EPB. For example, it is possible to control the operation of the motors RI, LI facing towards the inside of the motorcar firstly and then the motors RE, LE facing towards the outside of the vehicle. Alternatively, the electronic selecting and routing device 30 makes it possible to drive one inner and one outer motor.

Furthermore, with the electronic selecting and routing device 30 it is possible to drive the motors of the same caliper and then the motors of the other caliper at the same time.

Furthermore, the electronic selecting and routing device 30 makes it possible to drive the electric motors of the two brake calipers for time intervals T1, T2 of pre-set duration, comprised from a few tens of milliseconds to hundreds of milliseconds. In this manner, a more uniform piston advancement can be produced.

The present invention further relates to a motor vehicle which comprises an electro-actuated brake apparatus 100 according to any one of the embodiments described above.

The aforementioned electronic control unit 50 stores in a respective memory application software configured to implement the method which implements the control logic of the present invention. Such application software is implemented, in particular, by means of functional blocks.

In an example of embodiment, the parking-braking method of the vehicle 2 comprising the steps of:
providing at least a first electro-actuated brake caliper 10 associated with a first wheel 3 of the vehicle 2;
providing at least a second electro-actuated brake caliper 20 associated with a second wheel 4 of the vehicle 2;
providing an electronic device 30 for selecting and routing electrical signals, said device comprising:
   a first IN1 and a second IN2 input to receive electrical signals S1, S2 for actuating electro-actuated brake calipers, 10, 20;
   a first OU1 and at least a further first OU1′ output connected to a first RI and at least a further first RE electric motor, respectively, of such at least a first electro-actuated brake caliper 10;
   a second OU2 and at least a further second OU2′ output connected to a second LE and at least a further second LI electric motor, respectively, of such at least a second electro-actuated brake caliper 20.

The method is characterized in that it comprises the further step of selectively routing, by the electronic device 30, the aforesaid electrical actuation signals S1, S2 towards any two of said: first output OU1, second output OU2, at least a further first output OU1′ and at least a further second output OU2′ to activate the electric motors of both said at least a first brake caliper 10 and said at least a second brake caliper 20 to generate a parking braking action on the vehicle 2.

In an example of embodiment, the method further comprises the steps of:
applying an at least temporary parking braking action with: the first RI and at least further first RE electric motors of the at least a first electro-actuated brake caliper 10, second LE, and at least further second LI electric motors of the at least a second electro-actuated brake caliper 20;
applying a permanent parking braking action, i.e., until deactivation by the user, with at least one of said first RI, at least a further first RE, second LE, and at least a further second LI electric motors to generate a parking braking action on the vehicle 2.

In an example of embodiment, the method comprises:
defining a first amount of a temporary braking action F1, i.e. a first braking force;
defining a second amount of a permanent braking action F2, i.e. a second braking force.

Such a first amount of a temporary braking F1 is less than the second amount of a permanent braking action F2.

In a first example of embodiment, the aforesaid step of applying an at least temporary parking braking action comprises the further steps of:
activating, during a first interval of time T1, the first RI and said at least further second LI electric motors to apply said first amount of temporary braking action F1 to the first 10 and second 20 electro-actuated brake calipers;
keeping deactivated, during the first time T1, the at least further RE and said second LE electric motors;
activating, during a second interval of time T2 following and equal to the first time interval T1, the at least further first RE and the second LE electric motors to apply said first amount of temporary braking action F1 to the first 10 and second 20 electro-actuated brake calipers;
keeping deactivated, during the second time interval T2, the first RI, and the at least further second electric motor LI.

In an example of embodiment, the step of applying a permanent parking braking action comprises the further step of activating, until the deactivation by the user, at least one of the aforesaid first RI, at least a further first RE, second LE, and at least a further second LI electric motors to apply said second amount of permanent braking action F2 to the first 10 or second 20 electro-actuated brake caliper or both to generate a parking braking action on the vehicle 2.

Furthermore, it is provided to release the temporary parking braking action only from the electric motors not concerned by said permanent parking braking action.

Referring to FIGS. 8, 9, and 10, an example of a hydraulic and electromechanical service and parking disc brake 200 comprising a monobloc brake caliper 101 is described. Such a brake caliper 101 comprises two pistons actuated by two electric motors 117 controllable by an electronic control unit 120. Such an electronic control unit 120, which substantially corresponds to the electronic unit 50 described above, can control the electric motors 117 through the electronic routing device 30 suggested by the present invention.

Although a monobloc hydraulic and electromechanical disc brake caliper 101 with two electric motors is shown in FIG. 8, the present invention may also advantageously be applied to hydraulic and electromechanical disc brake calipers having a greater number of pistons, e.g. four or six pistons and, possibly a corresponding greater number of electric actuating motors.

The hydraulic and electromechanical service and parking disc brake 200 comprises the caliper 101 with two side walls 102 which mutually delimit a disc space 103 for accommodating a portion of a brake disc 104.

Furthermore, the disc brake 200 comprises means for fixing the caliper 101 to the suspension of a vehicle and at least two pads 105 each supported to one of the side walls 102, respectively.

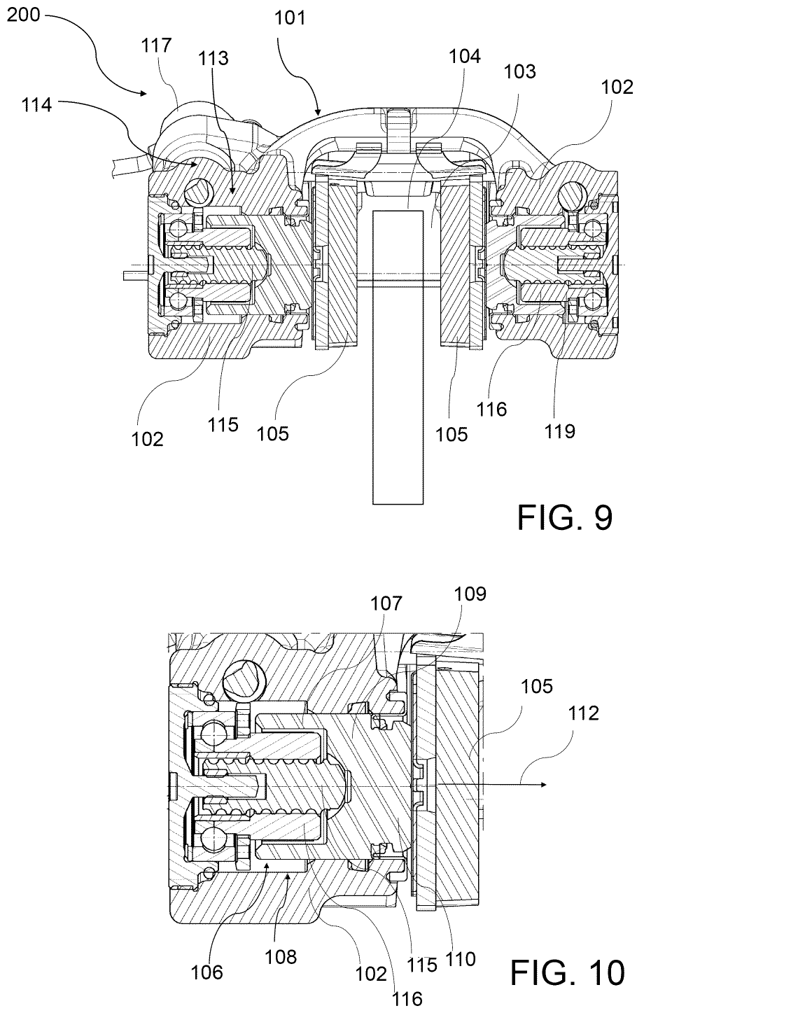

The disc brake 200 comprises a service braking system 106, having at one hydraulic actuator 107 positioned in each of the side walls 102. Each of the two hydraulic actuator 107 shown in FIG. 9 comprises a hydraulic cylinder 108 formed in the side wall 102 and a piston 109 accommodated in the hydraulic cylinder 108 and having a free end 110 facing the pad 105.

Such a hydraulic cylinder 108 is in communication with a system 111 for feeding and pressurizing a hydraulic fluid for applying hydraulic pressure to the piston 109 and causing the piston 109 to translate in an actuating direction 112 towards the brake disc 104 and clamp the pad 105 against the brake disc 104.

Furthermore, the disc brake 200 comprises a parking braking system 113 having an electromechanical actuator 114 positioned in each of the side walls 102, respectively. The caliper 101 comprises two electro-mechanical actuators 114.

Each electromechanical actuator 114 comprises a screw-nut assembly 115, 116 having a rotary member 116 and a translational member 115 and configured to convert a rotary motion of the rotary member 116 into a translational motion of the translational member 115.

The screw-nut assembly 115, 116 is connected in the hydraulic cylinder 108 to translate and tighten the translational member 115 in the actuating direction 112 against the piston 109 to lock it.

The two electric motors 117 of the disc brake 200 are each connected to a power supply 118 to actuate the screw-nut assembly 115, 116 associated with each piston. The disc brake 200, further comprises transmission mechanism 119 connected between the electric motor 117 and the rotary member 116.

It is worth noting that the electromechanical actuator 114 is self-locking due to a transmission irreversibility thereof so that, when the electric motor 117 is off, a translational stress of the translational member 115 cannot cause the translational member 115 to move away from the brake disc 104.

According to an alternative embodiment, e.g. if the caliper is a so-called floating caliper, the parking braking system 113 may comprise a single electromechanical actuator 114 positioned at only one of the side walls 102 which can be activated to block the pads 105 against the brake disc 104. In this case, the single electromechanical actuator 114 can be configured as described above.

The electronic control unit 120 of a disc brake 200 is connected to the service braking system 106 and to brake the parking braking system 113 and a user interface 121. Such a user interface 121 comprises, for example, a user interface 122, having, for example, a service braking control interface, e.g. a service pedal or a service button or a service lever, and a parking braking control interface 123, e.g. a parking pedal or a parking button or a parking lever.

Such a control unit 120 may comprise an electric, electromechanical, electro-hydraulic and/or electronic control system suited to control the pressurization of the hydraulic fluid and the drive of the electric motor 117. Such a control unit 120 is configured and/or programmed to perform the control functions of the brake 200 in the desired manner.

In the case of the hydraulic and electromechanical service and parking disc brake 200 comprising the brake caliper 101 in FIGS. 8-10, a step of defining a pressure target value in the hydraulic circuit of the caliper 101 is provided before the steps of controlling described above.

It is worth noting that the hydraulic pressure can be generated by hydraulic modulators on the vehicle, e.g., stability control (ESC) modulators, or electric power brakes, or electro-hydraulic actuators hydraulically connected to the caliper.

In particular, in response to a parking brake user command, the control unit 120 is configured to actuate:
the service braking system 106 to move the piston 109 in the actuating direction 112 towards the brake disc 104 in a parking position in which it clamps the pad 105 against the brake disc 104, and
the parking braking system 113 for locking the piston 109 in the parking position and for preventing a return movement of the piston 109.

In response to the parking brake user command, the control unit 120 is configured for:
actuating the service braking system 106 by moving the piston 109 to the parking position in which it pushes the pad 105 against the brake disc 104;
when the target pressure is reached in the hydraulic circuit of the caliper 101, actuating the electric motor 117 in a forward direction upon the actuation of the service braking system 106 and with the piston 109 already in the parking position, by translating a translational member 115 in the actuating direction 112 against the piston 109 to lock it in the parking position and prevent a return movement thereof;
once the piston 109 has been locked in the parking position, deactivating the service braking system 106 by reducing the pressure of the hydraulic fluid, and turning the electric motor 117 off.

In this manner, the piston 109 remains locked due to the transmission irreversibility of the electromechanical actuator 114.

In response to a user command to release the parking condition, the control unit 120 is configured for:
firstly actuating the hydraulic actuator 107 to provide pressure on the piston 109 and unloads the screw-nut assembly 115, 116 of the electromechanical actuator 114;
when the screw-nut assembly 115, 116 is unloaded, actuating the electromechanical actuator 114 to detach the translational member 115 from the piston 109;
when the translational member 115 is detached from the piston 109, actuating the hydraulic actuator 107 to lower the hydraulic pressure again and interrupt the parking.

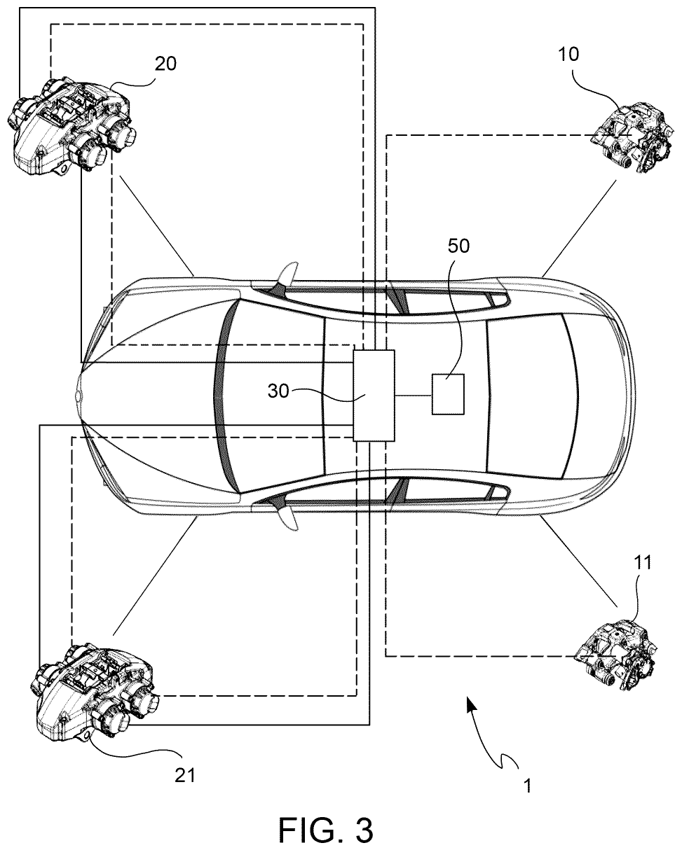

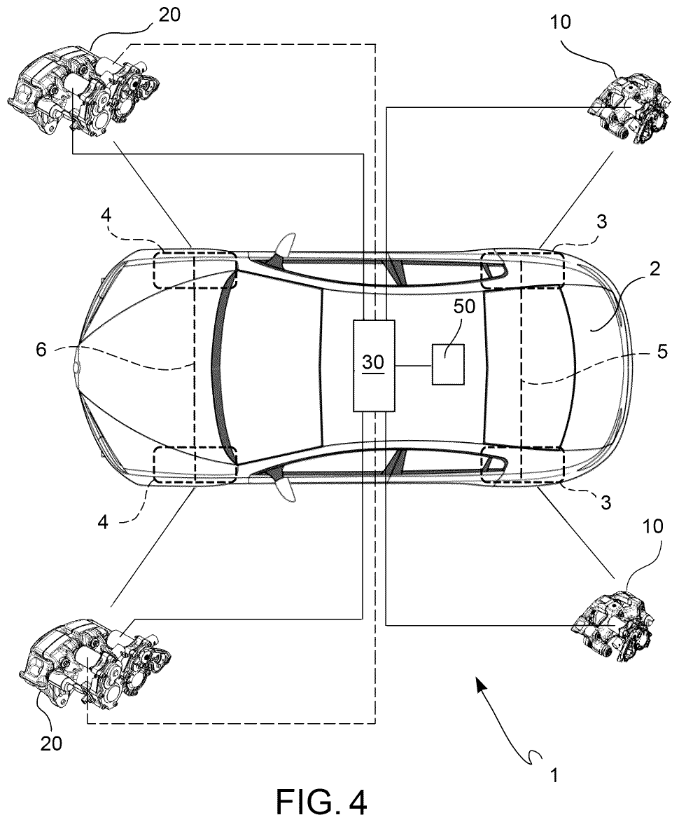

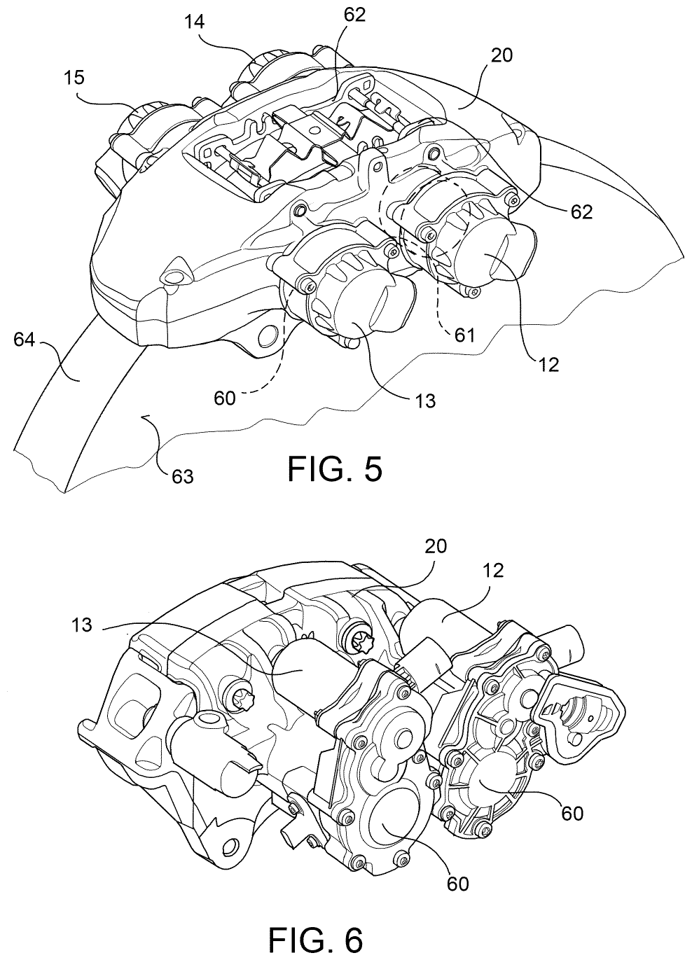

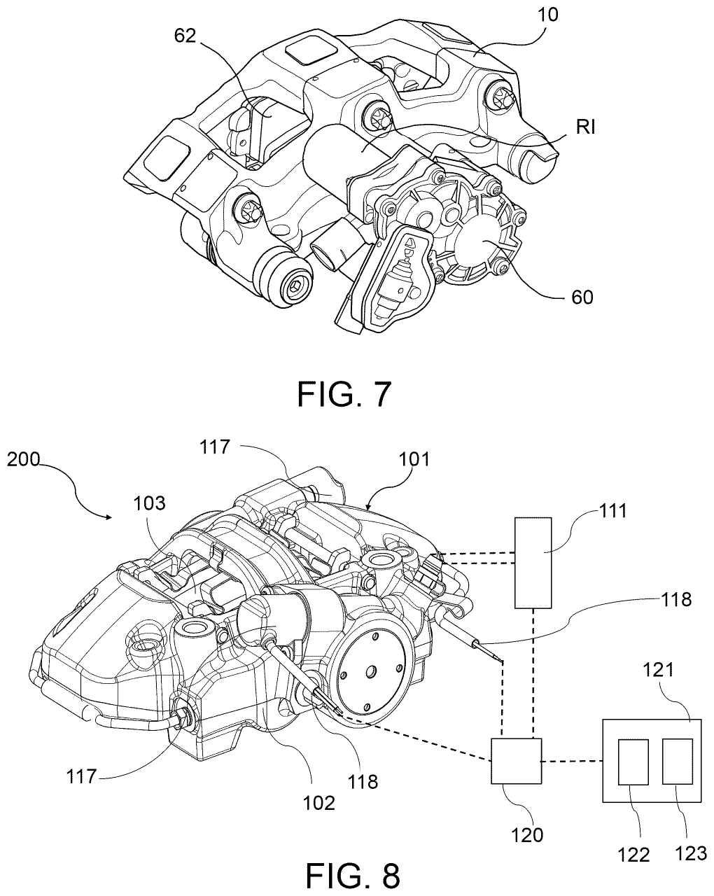

A possible parking-braking assembly according to the invention is described below with reference to FIGS. 3-7.

According to a general embodiment, a parking-braking assembly 1 of a vehicle 2 comprises at least a first brake caliper 10 associated with a wheel 3 of the rear axle 5 of vehicle 2.

Furthermore, said assembly comprises at least one further first brake caliper 11 associated with a wheel 4 of the front axle 6 of said vehicle 2.

In an example of embodiment, all the brake calipers 10, 11, 20, 21 of the braking system 1 of the vehicle 2 are electro-actuated brake calipers to avoid hydraulic braking devices and circuits on the vehicle 2.

In a different example of embodiment, the brake calipers of the braking system 1 of the vehicle 2 comprise both electro-actuated brake calipers and hydraulic and electromechanical service and parking brake calipers 101 similar to that described with reference to FIGS. 8-10.

Although reference is made hereafter to the example of embodiment in which all vehicle brake calipers 2 are electro-actuated calipers, the properties of the invention are also applicable to hydraulic and electromechanical service and parking brake calipers 101.

With further advantage, both said brake caliper 10 and said further first brake caliper 11 are at least also parking brake calipers.

According to an embodiment, said system 1 comprises an electronic control unit 50 configured to generate a first S1 and a second S2 electrical parking command signal to actuate said electro-actuated brake calipers 10, 11, 20, 21.

According to an embodiment, said electro-actuated brake calipers 10, 11, 20, 21 and/or said electronic control unit 50 are configured to apply a constant parking action on the vehicle 2 also when the vehicle is parked.

According to an embodiment, said electro-actuated brake calipers 10, 11, 20, 21 and/or said electronic control unit 50 are configured to apply a constant parking action on the vehicle 2 also when the vehicle is parked and off.

According to an embodiment, each electro-actuated caliper 10, 11, 20, 21 comprises at least one electric motor RI, RE, LE, LI, 12, 13, 14, 15 which acts, either directly or by means of a reduction gear 60, on a piston 61 which biases a brake pad 62, which, during the braking action, abuts against a braking surface 63 of a brake disc 64.

Alternately, said at least one electric motor RI, RE, LE, LI, 12, 13, 14, 15 comprises a motor locking device 65 (not shown in the figures) which acts by blocking the movement of the electric motor when the electric motor RI, RE, LE, LI, 12, 13, 14, 15 with the vehicle 2 stopped; or said reducer 60 is an irreversible reducer, i.e. it allows a movement of the piston 61 if it is actuated by the electric motor RI, RE, LE, LI, 12, 13, 14, 15, but it does not allow the piston 61 to retract with the sole bias of the brake pad 62 on which said piston acts.

According to an embodiment, at least one second brake caliper 20 is associated with a wheel 3 of the rear axle 5 of said vehicle 2.

The at least one further second brake caliper 21 is associated with a wheel 4 of the front axle 6 of said vehicle 2.

All four brake calipers 10, 11, 20, 21 of the braking system 1 of the vehicle 2 are electro-actuated brake calipers.

At least one electro-actuated brake caliper 10 or 11 of said rear axle 5 and at least one electro-actuated brake caliper 20 or 21 of said front axle 6 are at least also parking brake calipers of said vehicle 2.

According to an embodiment, at least two electro-actuated brake calipers 10 and 11 of said rear axle 5 and at least two electro-actuated brake calipers 20 and 21 of said front axle 6 are at least also parking brake calipers of the vehicle 2.

According to an embodiment, at least one electro-actuated caliper 10, 11, 20, 21 comprises at least two electric motors RI, RE, LE, LI, 12, 13, 14, 15.

At least one of said at least two electric motors RI, RE, LE, LI, 12, 13, 14, 15 generates a parking action of the vehicle 2.

According to an embodiment, said rear axle 5 comprises two opposite rear wheels 3 and each rear wheel 3 cooperates with at least one rear axle electro-actuated caliper 10, 11.

Each of said electro-actuated calipers 10, 11 comprises at least two electric motors RI, RE, LE, LI.

At least one of said at least two electric motors RI, RE, LE, LI of each of said electro-actuated calipers 10, 11 generates a parking action of the vehicle 2.

According to an embodiment, said front axle 6 comprises two opposite front wheels 4 and each front wheel 4 cooperates with at least one front axle electro-actuated caliper 20, 21.

Each of said electro-actuated calipers 20, 21 comprises at least two electric motors 12, 13, 14, 15.

At least one of said at least two electric motors 12, 13, 14, 15 of each of said electro-actuated calipers 20, 21 generates a parking action of the vehicle 2.

According to an embodiment, at least one electro-actuated caliper 10, 11, 20, 21 comprises at least two electric motors RI, RE, LE, LI, 12, 13, 14, 15.

Both said at least two electric motors RI, RE, LE, LI, 12, 13, 14, 15 generate an at least temporary parking action of the vehicle 2.

According to an embodiment, said front axle 6 comprises two opposite front wheels 4 and each front wheel 4 cooperates with at least one front axle electro-actuated caliper 20, 21.

Each of said electro-actuated calipers 20, 21 comprises at least two electric motors 12, 13, 14, 15.

Both said at least two electric motors 12, 13, 14, 15 of each of the said electro-actuated calipers 20, 21 generate an at least temporary parking action of the vehicle 2.

According to an embodiment, said rear axle 5 comprises two opposite rear wheels 3 and each rear wheel 3 cooperates with at least one rear axle electro-actuated caliper 10, 11.

Each of said electro-actuated calipers 10, 11 comprises at least two electric motors RI, RE, LE, LI.

Both said at least two electric motors RI, RE, LE, LI of each of said electro-actuated calipers 10, 11 generates an at least temporary parking action of the vehicle 2.

According to an embodiment, said front axle 6 comprises two opposite front wheels 4 and each front wheel 4 cooperates with at least one front axle electro-actuated caliper 20, 21.

Said front axle electro-actuated calipers 20, 21 are floating calipers.

Said front axle electro-actuated calipers 20, 21 each comprise two electric motors 12, 13, 14, 15.

At least one of said at least two electric motors 12, 13, 14, 15 of each of said electro-actuated calipers 20, 21 generates a parking action of the vehicle 2.

According to an embodiment, said front axle 6 comprises two opposite front wheels 4 and each front wheel 4 cooperates with at least one front axle electro-actuated caliper 20, 21.

Said electro-actuated calipers 20, 21 of the front axle are one-piece calipers or fixed with respect to a support thereof, such as a vehicle stub axle.

Said front axle electro-actuated calipers 20, 21 each comprise two opposed pairs of electric motors 12, 13, 14, 15.

At least two of said electric motors 12, 13, 14, 15, arranged opposite to each other, of each of said electro-actuated calipers 20, 21 generates a parking action of the vehicle 2.

According to an embodiment, said rear axle 5 comprises two opposite rear wheels 3 and each rear wheel 3 cooperates with at least one rear axle electro-actuated caliper 10, 11.

Said rear axle electro-actuated calipers 10, 11 are floating calipers.

Said rear axle electro-actuated calipers 10, 11 each comprise a single electric motor RI, RE, LE, LI.

Said electric motor RI, RE, LE, LI of each of said electro-actuated calipers 10, 11 generates a parking action of the vehicle 2.

A procedure for activating the parking brake assembly will be described below.

According to a general embodiment, a parking-braking method of a vehicle 2 comprises the following steps:
providing at least one electro-actuated first brake caliper 10 associated with a wheel 3 of the rear axle 5 of said vehicle 2;
providing at least one further electro-actuated first brake caliper 11 associated with a wheel 4 of the front axle 6 of said vehicle 2;
avoiding hydraulic braking devices and circuits on the vehicle 2;
applying a parking-braking action with both said brake caliper 10 and said further first brake caliper 11 to generate a parking-braking action on said vehicle 2.

According to a further embodiment, the method includes the following steps:
providing two opposite rear wheels 4 in said front axle 6, wherein and each front wheel 4 cooperates with at least one front axle electro-actuated caliper 20, 21;
providing two opposite rear wheels 3 in said rear axle 5, wherein each rear wheel 3 cooperates with at least one rear axle electro-actuated caliper 10, 11;
applying a parking-braking action with all the electro-actuated calipers 20, 21 on the front axle and all the electro-actuated calipers 10, 11 on the rear axle.

According to a further embodiment, the method includes the following steps:
providing at least two electric motors RI, RE, LI, LE, 12, 13, 14, 15 for each electro-actuated caliper 10, 11, 20, 21;
applying a parking-braking action with at least one of said at least two electric motors RI, RE, LI, LE, 12, 13, 14, 15 to generate a parking-braking action on said vehicle 2.

According to a further embodiment, the method includes the following steps:
providing at least two electric motors RI, RE, LI, LE, 12, 13, 14, 15 for each electro-actuated caliper 10, 11, 20, 21;
applying an at least temporary parking-braking action with said at least two electric motors RI, RE, LI, LE, 12, 13, 14, 15;
applying a permanent parking-braking action, i.e. until it is deactivated by the user, with at least one of said at least two electric motors RI, RE, LI, LE, 12, 13, 14, 15 to generate a parking-braking action on said vehicle 2.

According to a further embodiment, the method includes the following steps:
providing at least two electric motors RI, RE, LI, LE, 12, 13, 14, 15 for each electro-actuated caliper 10, 11, 20, 21;
applying an at least temporary parking-braking action with said at least two electric motors RI, RE, LI, LE, 12, 13, 14, 15;
applying a permanent parking-braking action, i.e. until it is deactivated by the user, with at least one of said at least two electric motors RI, RE, LI, LE, 12, 13, 14, 15 to generate a parking-braking action on said vehicle 2;
releasing the temporary parking braking action only from electric motors RI, RE, LI, LE, 12, 13, 14, 15 not concerned by said permanent parking braking action.

According to a further embodiment, the method includes the following steps:
defining a first amount of a temporary braking F1;
defining a second amount of a permanent braking F2;
providing at least two electric motors RI, RE, LI, LE, 12, 13, 14, 15 for at least one electro-actuated caliper 10, 11, 20, 21;
applying said temporary parking-braking action F1 with said at least two electric motors RI, RE, LI, LE, 12, 13, 14, 15;
applying said permanent parking-braking action F2, i.e. until it is deactivated by the user, with at least one of said at least two electric motors RI, RE, LI, LE, 12, 13, 14, 15 to generate a parking-braking action on said vehicle 2;
releasing the temporary parking braking action F1 only from electric motors RI, RE, LI, LE, 12, 13, 14, 15 not concerned by said permanent parking braking action.

According to a further embodiment, the method includes the following steps:
defining a first amount of a temporary braking F1;
defining a second amount of a permanent braking F2;
wherein said first entity of a temporary braking action F1 is defined as equal to half the second entity of a permanent braking action F2;
providing at least two electric motors RI, RE, LI, LE, 12, 13, 14, 15 for at least one electro-actuated caliper 10, 11, 20, 21;
applying said temporary parking-braking action F1 with said at least two electric motors RI, RE, LI, LE, 12, 13, 14, 15;
applying said permanent parking-braking action F2, i.e. until it is deactivated by the user, with at least one of said at least two electric motors RI, RE, LI, LE, 12, 13, 14, 15 to generate a parking-braking action on said vehicle 2;
releasing the temporary parking braking action F1 only from electric motors RI, RE, LI, LE, 12, 13, 14, 15 not concerned by said permanent parking braking action.

According to a further embodiment, the method includes the following steps:
defining a first amount of a temporary braking F1;
defining a second amount of a permanent braking F2;
providing at least two electric motors RI, RE, LI, LE, 12, 13, 14, 15 for at least one electro-actuated caliper 10, 11, 20, 21;
applying said temporary parking-braking action F1 with said at least two electric motors RI, RE, LI, LE, 12, 13, 14, 15;
applying said permanent parking-braking action F2, i.e. until it is deactivated by the user, with at least one of said at least two electric motors RI, RE, LI, LE, 12, 13, 14, 15 to generate a parking-braking action on said vehicle 2;
releasing the temporary parking braking action F1 only from electric motors RI, RE, LI, LE, 12, 13, 14, 15 not concerned by said permanent parking braking action;
at the end of the parking, releasing said permanent parking-braking action F2 with said at least one of said at least two electric motors RI, RE, LI, LE, 12, 13, 14, 15 until said temporary parking braking action F1 is achieved; and thus
releasing said temporary parking braking action F1 with said at least two electric motors RI, RE, LI, LE, 12, 13, 14, 15.

The person skilled in the art may make many changes and adaptations to the embodiments of the parking-braking assembly described above or may replace elements with others, which are functionally equivalent, to satisfy contingent needs without however departing from the scope of the appended claims.

### REFERENCES

1 braking system
2 vehicle
3 rear wheel
4 front wheel
5 rear axle
6 front axle
10 rear axle first electro-actuated brake caliper
11 rear axle further first electro-actuated brake caliper
12 front caliper electric motor
13 front caliper electric motor
14 front caliper further electric motor
15 front caliper further electric motor
20 front axle second electro-actuated brake caliper
21 front axle further second electro-actuated brake caliper
30 electronic device
50 electronic control unit
60 reducer
61 piston
62 brake pad
63 braking surface
64 brake disc
100 parking brake apparatus
200 hydraulic and electromechanical service and parking disc brake
101 monobloc brake caliper
102 side wall
103 disc space
104 brake disc
105 pads
106 service braking system
107 hydraulic actuator
108 hydraulic cylinder
109 piston
110 free end
111 hydraulic fluid supply and pressurization system
112 actuating direction
113 parking braking system
114 electro-mechanical actuator
115 screw-nut assembly translational member
116 screw-nut assembly rotary member
117 electric motor
118 power supply
119 transmission mechanism
120 electronic control unit
121 user interface
122 service brake control interface
123 parking brake control interface
IN1 first input
IN2 second input
S1 first electric signal
S2 second electric signal
CP1 first power circuit
CP2 second power circuit
OU1 first output
OU1′ further first output
OU2 second output
OU2′ further second output
RI first rear caliper first electric motor
RE first rear caliper further first electric motor
LE second rear caliper second electric motor
LI second rear caliper further second electric motor
SW1 electrical connection means, first switch controlled in switching
SW2 electrical connection means, second switch controlled in switching
SW3 electrical connection means, third switch controlled in switching
SW4 electrical connection means, fourth switch controlled in switching
EN1 first control signal
EN2 second control signal
T1 first time interval
T2 second time interval

1-10. (canceled)

11. A parking-braking assembly of a vehicle, comprising:
at least one first brake caliper associated with a wheel of a rear axle of the vehicle;
at least one further first brake caliper associated with a wheel of a front axle of the vehicle; wherein
all brake calipers of the parking-braking assembly of the vehicle are electro-actuated brake calipers to avoid hydraulic braking devices and circuits on the vehicle;
and wherein both said first brake caliper and said further first brake caliper are at least also parking brake calipers.

12. The parking-braking assembly of claim 11, wherein said parking-braking assembly comprises an electronic control unit configured to generate a first electrical parking command signal and a second electrical parking command signal to actuate said electro-actuated brake calipers.

13. The parking-braking assembly of claim 11, wherein said parking-braking assembly comprises an electronic control unit, and wherein said electro-actuated brake calipers and/or said electronic control unit are configured to apply a constant parking action on the vehicle also when the vehicle is parked.

14. The parking-braking assembly of claim 11, wherein said parking-braking assembly comprises an electronic control unit, and wherein said electro-actuated brake calipers and/or said electronic control unit are configured to apply a constant parking action on the vehicle also when the vehicle is parked and off.

15. The parking-braking assembly of claim 11, wherein each electro-actuated brake caliper comprises at least one electric motor which acts, either directly or by a reduction gear, on a piston which biases a brake pad, which, during a braking action, abuts against a braking surface of a brake disc; and wherein
alternatively,
said at least one electric motor comprises a motor locking device which acts by blocking movement of the at least one electric motor when the at least one electric motor is not powered when the vehicle is stopped;
or
said reduction gear is an irreversible reducer that allows movement of the piston if actuated by the at least one electric motor, but does not allow the piston to retract with the sole bias of the brake pad on which said piston acts.

16. The parking-braking assembly of claim 11, wherein
at least one second brake caliper is associated with a wheel of the rear axle of the vehicle; wherein
at least one further second brake caliper is associated with a wheel of the front axle of the vehicle; wherein
all four brake calipers of the parking-braking assembly of the vehicle are electro-actuated brake calipers;
and wherein
at least one electro-actuated brake caliper of said rear axle and at least one electro-actuated brake caliper of said front axle are at least also parking brake calipers of the vehicle;
and/or wherein
at least two electro-actuated brake calipers of said rear axle and at least two electro-actuated brake calipers of said front axle are at least also parking brake calipers of the vehicle.

17. The parking-braking assembly of claim 11, wherein
at least one electro-actuated brake caliper comprises at least two electric motors; and wherein
at least one of said at least two electric motors generates a parking action of the vehicle.

18. The parking-braking assembly of claim 11, wherein
said rear axle comprises two opposite rear wheels and each rear wheel cooperates with at least one rear axle electro-actuated caliper; and wherein
each rear axle electro-actuated caliper comprises at least two electric motors; and wherein
at least one of said at least two electric motors of each rear axle electro-actuated caliper generates a parking action of the vehicle.

19. The parking-braking assembly of claim 11, wherein
said front axle comprises two opposite front wheels and each front wheel cooperates with at least one front axle electro-actuated caliper; and wherein
each front axle electro-actuated caliper comprises at least two electric motors; and wherein
at least one of said at least two electric motors of each front axle electro-actuated caliper generates a parking action of the vehicle.

20. The parking-braking assembly of claim 11, wherein
at least one electro-actuated brake caliper comprises at least two electric motors; and wherein
both said at least two electric motors generate an at least temporary parking action of the vehicle.

21. The parking-braking assembly of claim 11, wherein
said front axle comprises two opposite front wheels and each front wheel cooperates with at least one front axle electro-actuated caliper; and wherein
each front axle electro-actuated caliper comprises at least two electric motors; and wherein
both said at least two electric motors of each front axle electro-actuated caliper generate an at least temporary parking action of the vehicle.

22. The parking-braking assembly of claim 11, wherein
said rear axle comprises two opposite rear wheels and each rear wheel cooperates with at least one rear axle electro-actuated caliper; and wherein
each rear axle electro-actuated caliper comprises at least two electric motors; and wherein
both said at least two electric motors of each rear axle electro-actuated caliper generate an at least temporary parking action of the vehicle.

23. The parking-braking assembly of claim 11, wherein
said front axle comprises two opposite front wheels and each front wheel cooperates with at least one front axle electro-actuated caliper; and wherein
said front axle electro-actuated calipers are floating calipers; and wherein
said front axle electro-actuated calipers each comprise two electric motors; and wherein
at least one of said at least two electric motors of each of said front axle electro-actuated calipers generates a parking action of the vehicle.

24. The parking-braking assembly of claim 11, wherein
said front axle comprises two opposite front wheels and each front wheel cooperates with at least one front axle electro-actuated caliper; and wherein
said front axle electro-actuated calipers are monoblock or fixed calipers; and wherein
said front axle electro-actuated calipers each comprise two opposed pairs of electric motors; and wherein
at least two of said electric motors, arranged opposite to each other, of each of said front axle electro-actuated calipers generate a parking action of the vehicle.

25. The parking-braking assembly of claim 11, wherein
said rear axle comprises two opposite rear wheels and each rear wheel cooperates with at least one rear axle electro-actuated caliper; and wherein
said rear axle electro-actuated calipers are floating calipers; and wherein
said rear axle electro-actuated calipers each comprise a single electric motor; and wherein
said single electric motor of each of said rear axle electro-actuated calipers generates a parking action of the vehicle.

26. A parking-braking method of a vehicle, comprising:
providing at least one electro-actuated first brake caliper associated with a wheel of a rear axle of the vehicle;
providing at least one further electro-actuated first brake caliper associated with a wheel of a front axle of the vehicle; and
applying a parking-braking action with both said at least one electro-actuated first brake caliper and said at least one further electro-actuated first brake caliper to generate a parking-braking action to the vehicle.

27. The parking-braking method of claim 26, further comprising:
providing two opposite front wheels in said front axle, wherein each front wheel cooperates with at least one front axle electro-actuated caliper;
providing two opposite rear wheels in said rear axle, wherein each rear wheel cooperates with at least one rear axle electro-actuated caliper;
applying a parking-braking action with all front axle electro-actuated calipers and all rear axle electro-actuated calipers;
and/or
providing at least two electric motors for each electro-actuated caliper;
applying a parking-braking action with at least one of said at least two electric motors to generate a parking-braking action to the vehicle.

28. The parking-braking method of claim 26, further comprising:
providing at least two electric motors for each electro-actuated caliper;
applying an at least temporary parking-braking action with said at least two electric motors; and
applying a permanent parking-braking action, until deactivation of the permanent parking-braking action by a user, with at least one of said at least two electric motors to generate a parking-braking action to the vehicle.

29. The parking-braking method of claim 26, further comprising:
providing at least two electric motors for each electro-actuated caliper;
applying an at least temporary parking-braking action with said at least two electric motors;
applying a permanent parking-braking action, until deactivation of the permanent parking-braking action by a user, with at least one of said at least two electric motors to generate a parking-braking action to the vehicle; and
releasing the at least temporary parking-braking action only from electric motors not concerned by the permanent parking-braking action.

30. The parking-braking method of claim 26, further comprising:
defining a first entity of a temporary parking-braking action;
defining a second entity of a permanent parking-braking action;
providing at least two electric motors for at least one electro-actuated caliper;
applying said temporary parking-braking action with said at least two electric motors;
applying said permanent parking-braking action, until deactivation of the permanent parking-braking action by a user, with at least one of said at least two electric motors to generate a parking-braking action to the vehicle; and
releasing the temporary parking-braking action only from electric motors not concerned by the permanent parking-braking action;
and/or
defining a first entity of a temporary parking-braking action;
defining a second entity of a permanent parking-braking action;
wherein said first entity of the temporary parking-braking action is defined as equal to half the second entity of the permanent parking-braking action;
providing at least two electric motors for at least one electro-actuated caliper;
applying said temporary parking-braking action with said at least two electric motors;
applying said permanent parking-braking action, until deactivation of the permanent parking-braking action by a user, with at least one of said at least two electric motors to generate a parking-braking action to the vehicle; and
releasing the temporary parking-braking action only from electric motors not concerned by the permanent parking braking action;
and/or
defining a first entity of a temporary parking-braking action;
defining a second entity of a permanent parking-braking action;
providing at least two electric motors for at least one electro-actuated caliper;
applying said temporary parking-braking action with said at least two electric motors;
applying said permanent parking-braking action, until deactivation of the permanent parking-braking action by a user, with at least one of said at least two electric motors to generate a parking-braking action to the vehicle;
releasing the temporary parking braking action only from electric motors not concerned by said permanent parking-braking action;
at the end of parking, releasing said permanent parking-braking action with at least one of said at least two electric motors until said temporary parking-braking action is achieved; and
releasing said temporary parking-braking action with said at least two electric motors.
